(19) United States
(12) Patent Application Publication
(10) Pub. No.: US 2022/0405814 A1
(43) Pub. Date: Dec. 22, 2022

(54) INFORMATION PROCESSING DEVICE, CALCULATION METHOD, AND CALCULATION PROGRAM

(71) Applicant: TOYOTA JIDOSHA KABUSHIKI KAISHA, Aichi-ken (JP)

(72) Inventor: Masato ENDO, Nagoya-shi (JP)

(21) Appl. No.: 17/741,449

(22) Filed: May 11, 2022

(30) Foreign Application Priority Data
Jun. 22, 2021 (JP) 2021-103256

(51) Int. Cl. G06Q 30/02; G06Q 10/06; G06Q 50/30

(52) U.S. Cl. CPC G06Q 30/0283; G06Q 10/06398; G06Q 50/30

(57) ABSTRACT

A center server as an information processing device includes a processor configured to detect a predetermined event based on vehicle information on a vehicle, calculate a cost for each detected event, calculate a decrease amount obtained by subtracting the total cost, which is the sum of the costs for a predetermined period, from the total cost for the past predetermined period, and calculate a usage amount of a service that provides information on driving behaviors of a driver who drives the vehicle based on the calculated decrease amount.

### CROSS-REFERENCE TO RELATED APPLICATION

This application claims priority to Japanese Patent Application No. 2021-103256 filed on Jun. 22, 2021, incorporated herein by reference in its entirety.

### BACKGROUND

### 1. Technical Field

The present disclosure relates to an information processing device, a calculation method, and a calculation program, each of which is capable of calculating a usage amount of a service that provides information.

### 2. Description of Related Art

Japanese Unexamined Patent Application Publication No. 2017-134599 (JP 2017-134599 A) discloses a traffic accident prevention service device that ensures visibility of outcomes acquired from a service or a system introduced to prevent automobile accidents.

### SUMMARY

The traffic accident prevention service device described in JP 2017-134599 A demonstrates the outcomes of the service by displaying a reduction rate of a damage amount based on an accident damage amount provided by an insurance company. However, the reduction is not reflected in the usage amount. A business operator may hesitate to introduce a service aimed at preventing accidents, even though they are interested in such a service, if they cannot recover a usage cost of the service via a reduction in the damage amount.

The present disclosure provides an information processing device, a calculation method, and a calculation program, each of which is capable of promoting the introduction of a driving information service in which a usage amount reflects a cost reduction corresponding to a specific event, such as an accident.

An information processing device according to a first aspect of the present disclosure includes a processor. The processor is configured to detect a predetermined event based on vehicle information on a vehicle, calculate a cost for each detected event, calculate a decrease amount obtained by subtracting a total cost, which is a sum of costs for a predetermined period, from a total cost for a past predetermined period, and calculate a usage amount of a service that provides information on driving behaviors of a driver who drives the vehicle based on the calculated decrease amount.

The information processing device according to the first aspect calculates the usage amount related to the service that provides the information on driving behaviors of the driver who drives the vehicle. The information processing device calculates the cost for every detected event by the processor based on the vehicle information on the vehicle, and calculates the total cost by accumulating all individually calculated costs. The “event” herein includes at least one of an accident and a failure occurring in the vehicle. The processor is configured to calculate the decrease amount obtained by subtracting a total cost calculated for a predetermined period from the total cost calculated for the past predetermined period, and calculate the usage amount based on the decrease amount. With the information processing device, it is possible to promote the introduction of the driving information service in which the usage amount reflects the cost reduction corresponding to the specific event, such as an accident.

In the first aspect, the processor may calculate the usage amount in response to a predetermined trigger.

With such a configuration, it is possible to recalculate the usage amount again in response to a predetermined trigger.

In the first aspect, the predetermined trigger may be a case where the decrease amount is a predetermined amount.

With such a configuration, it is possible to calculate the usage amount in a case where a user can get meaningful outcomes from the service.

In the first aspect, the processor may calculate, as the usage amount, an amount obtained by multiplying the decrease amount by a variable ratio.

With such a configuration, it is possible to set the usage amount differently according to various factors of the service, for example, target audience or frequency of use.

In the first aspect, the processor may calculate, as the usage amount, a first usage amount collected every first period, and a second usage amount which is collected every second period and is obtained by subtracting the total sum of the first usage amount from the usage amount. The second period is longer than the first period.

With such a configuration, the usage amount may be calculated separately as the first usage amount every first period that are relatively shorter, and the second usage amount collected every second period that are relatively longer. For example, it is possible to set the first usage amount as a usage amount that is sufficient in terms of maintaining infrastructure, and the second usage amount as an incentive fee. With the information processing device, it is possible for the vehicle administrator to easily introduce the service and keep offering the service.

In the first aspect, the processor may calculate, in a case where the service has been introduced but not used to a certain extent, a third usage amount which is higher than the first usage amount and is collected every first period instead of the first usage amount.

With such a configuration, it is possible to promote the service by increasing the usage amount when the user does not use the service to a certain extent.

A calculation method according to a second aspect of the present disclosure is executed by a computer. The calculation method includes detecting a predetermined event based on vehicle information on a vehicle, calculating a cost for each detected event, calculating a decrease amount obtained by subtracting a total cost, which is a sum of costs for a predetermined period, from a total cost for a past predetermined period, and calculating a usage amount of a service that provides information on driving behaviors of a driver who drives the vehicle based on the calculated decrease amount.

The calculation method according to the second aspect is a method for calculating the usage amount related to the service that provides the information on driving behaviors of the driver who drives the vehicle. The calculation method is a method for calculating the cost for every detected event by the processor based on the vehicle information on the vehicle, and calculating the total cost by accumulating all individually calculated costs. The event is as described above. The computer executes calculating the decrease amount obtained by subtracting the total cost calculated for the predetermined period from the total cost calculated for the past predetermined period, and calculating the usage amount based on the decrease amount. With the calculation method, it is possible to promote the introduction of the driving information service in which the usage amount reflects the cost reduction corresponding to the specific event, such as an accident.

A calculation program according to a third aspect of the present disclosure causes a computer to execute detecting a predetermined event based on vehicle information on a vehicle, calculating a cost for each detected event, calculating a decrease amount obtained by subtracting a total cost, which is a sum of costs for a predetermined period, from a total cost for a past predetermined period, and calculating a usage amount of a service that provides information on driving behaviors of a driver who drives the vehicle based on the calculated decrease amount.

The calculation program according to the third aspect is a program for calculating the usage amount related to the service that provides the information on driving behaviors of the driver who drives the vehicle, which causes a computer to execute the processes below. In other words, the calculation program is a program to calculate the cost for every detected event based on the vehicle information on the vehicle, and to calculate the total cost by accumulating all individually calculated costs. The event is as described above. The computer executes calculating the decrease amount obtained by subtracting the total cost calculated for the predetermined period from the total cost calculated for the past predetermined period, and calculating the usage amount based on the decrease amount. With the calculation program, it is possible to promote the introduction of the driving information service in which the usage amount reflects the cost reduction corresponding to the specific event, such as an accident.

With each aspect of the present disclosure, it is possible to promote the introduction of the driving information service in which the usage amount of the service reflects the cost reduction corresponding to the specific event, such as an accident.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a schematic configuration example of a vehicle diagnostic system according to a first embodiment;

FIG. 2 is a diagram illustrating a hardware configuration of a vehicle according to the first embodiment;

FIG. 3 is a diagram illustrating a hardware configuration of a center server according to the first embodiment;

FIG. 4 is a diagram illustrating a functional configuration of the center server according to the first embodiment;

FIG. 5 is a flowchart illustrating a flow of a calculation notification process executed in the center server according to the first embodiment;

FIG. 6 is a flowchart illustrating a flow of a usage amount calculation process executed in the center server according to the first embodiment;

FIG. 7 is a diagram illustrating a calculation flow of a usage amount; and

FIG. 8 is a flowchart illustrating a flow of a calculation notification process executed in the center server according to a second embodiment.

### DETAILED DESCRIPTION OF EMBODIMENTS

A vehicle diagnostic system including the information processing device of the present disclosure will be described hereinbelow. The vehicle diagnostic system is a system that provides a driving diagnosis service for transport vehicles such as taxis and trucks. The driving diagnosis service is a service to analyze a driving situation of a transport vehicle based on the vehicle information acquired from the transport vehicle and to diagnose driving behaviors of a driver of the transport vehicle.

### First Embodiment

Overall Configuration

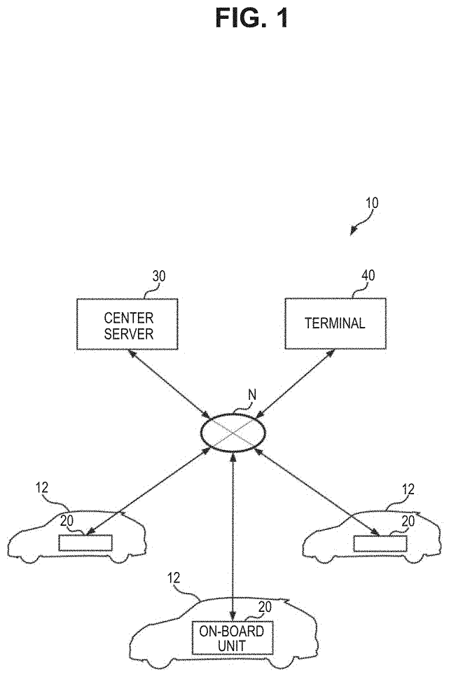

As shown in FIG. 1, a vehicle diagnostic system 10 of the first embodiment includes a plurality of vehicles 12, a center server 30 as the information processing device, and a terminal 40. Each vehicle 12 is equipped with an on-board unit 20. The on-board unit 20, the center server 30, and the terminal 40 are connected to each other via a network N. FIG. 1 depicts three vehicles 12, three on-board units 20 corresponding to the respective vehicles 12, and one terminal 40 for one center server 30. However the number of vehicles 12, on-board units 20, and terminals 40 is not limited thereto.

The vehicle 12 is exemplified by a transport vehicle such as a taxi or a truck. The center server 30 is installed in, for example, premises of a transportation company managing the vehicle 12 as the transport vehicle. The terminal 40 is exemplified by a smartphone or a personal computer owned by an administrator who manages the vehicle 12.

Vehicle

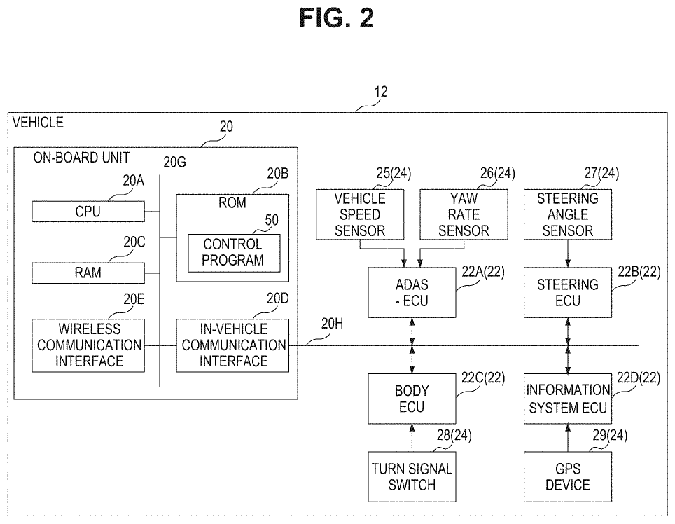

As shown in FIG. 2, the vehicle 12 according to the present embodiment includes an on-board unit 20, a plurality of electronic control units (ECUs) 22, and a plurality of in-vehicle devices 24.

The on-board unit 20 is configured to include a central processing unit (CPU) 20A, a read only memory (ROM) 20B, a random access memory (RAM) 20C, an in-vehicle communication interface 20D, and a wireless communication interface 20E. The CPU 20A, the ROM 20B, the RAM 20C, the in-vehicle communication interface 20D, and the wireless communication interface 20E are connected to each other so as to establish communication therebetween via an internal bus 20G.

The CPU 20A is a central processing unit that executes various programs and controls each unit. That is, the CPU 20A reads the program from the ROM 20B and executes the program using the RAM 20C as a work area.

The ROM 20B stores various programs and various data. The ROM 20B of the present embodiment stores a control program 50 that collects vehicle information related to a state and control of the vehicle 12 from the ECUs 22 and provides such information to the center server 30. The RAM 20C temporarily stores a program or data as a work area.

The in-vehicle communication interface 20D is an interface for connecting to each ECU 22. A communication protocol based on a CAN protocol is adopted in the interface. The in-vehicle communication interface 20D is connected to an external bus 20H.

The wireless communication interface 20E is a wireless communication module for establishing communication with the center server 30. A communication protocol such as 5G, LTE or Wi-Fi® is adopted in the wireless communication module. The wireless communication interface 20E is connected to the network N.

The ECUs 22 includes an advanced driver assistance system (ADAS)-ECU 22A, a steering ECU 22B, a body ECU 22C, and an information system ECU 22D.

The ADAS-ECU 22A performs integrated control for an advanced driver assistance system. The ADAS-ECU 22A is connected to a vehicle speed sensor 25 and a yaw rate sensor 26 constituting the in-vehicle device 24.

The steering ECU 22B controls power steering. The steering ECU 22B is connected to a steering angle sensor 27 constituting the in-vehicle device 24. The steering angle sensor 27 is a sensor that detects a steering angle obtained by a steering operation.

The body ECU 22C controls lights such as turn signals. The body ECU 22C is connected to a turn signal switch 28 constituting the in-vehicle device 24.

The information system ECU 22D controls a car navigation system, an audio device, and the like. The information system ECU 22D is connected to a GPS device 29 constituting the in-vehicle device 24. The GPS device 29 is a device that measures a current location of the vehicle 12. The GPS device 29 includes an antenna (not shown) that receives signals from a GPS satellite. Further, the GPS device 29 may be directly connected to the on-board unit 20.

Center Server

The center server 30 acquires the vehicle information from the on-board unit 20 of the vehicle 12, analyzes a driving state of the vehicle 12, and diagnoses driving behaviors of a driver. Further, the center server 30 has a function of calculating the cost when the accident or failure occurs in the vehicle 12, as well as the usage amount of the driving diagnosis service.

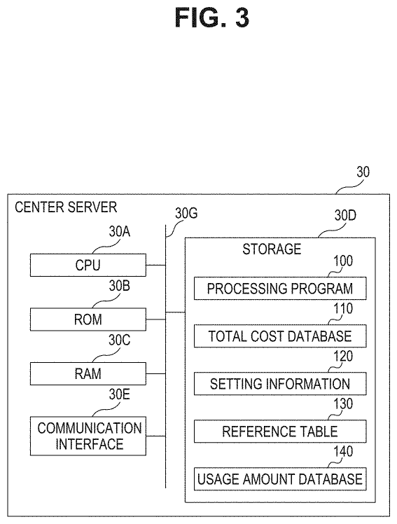

As shown in FIG. 3, the center server 30 is configured to include a CPU 30A, a ROM 30B, a RAM 30C, a storage 30D, and a communication interface 30E. The CPU 30A, the ROM 30B, the RAM 30C, the storage 30D, and the communication interface 30E are connected to each other so as to establish communication therebetween via an internal bus 30G. The functions of the CPU 30A, the ROM 308, the RAM 30C and the communication interface 30E are the same as those of the CPU 20A, the ROM 20B, the RAM 20C and the wireless communication interface 20E of the on-board unit 20 described above. The communication interface 30E may establish wired communication.

The storage 30D serving as a storage unit is configured by a storage device such as a hard disk drive (HDD) or a solid state drive (SSD), which stores various programs and various data. The storage 30D of the present embodiment stores a processing program 100, a total cost database 110, setting information 120, a reference table 130, and a usage amount database 140. The ROM 30B may store the processing program 100, the total cost database 110, the setting information 120, the reference table 130, and the usage amount database 140.

The processing program 100 as the calculation program is a program for controlling the center server 30. While executing the processing program 100, the center server 30 executes a diagnosis process for diagnosing driving behaviors of a driver who drives the vehicle 12 and a calculation notification process for calculating and notifying the usage amount of the driving diagnosis service.

The total cost database 110 is a database in which the total cost calculated by a calculation unit 230 (described later) is stored. The setting information 120 stores a pay rate used when calculating the usage amount of the driving diagnosis service.

The reference table 130 stores information referred to when calculating the cost when the accident or failure occurs, and in which list information indicating the cost required for each accident or failure is stored according to a classification. Referenced costs include vehicle repair costs, occupant treatment costs, insurance costs, leave compensation, and paperwork costs for dealing with accidents and failures. The usage amount database 140 stores the usage amount for each business operator who uses the driving diagnosis service.

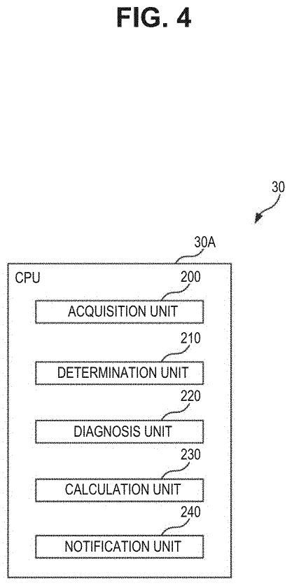

As shown in FIG. 4, the CPU 30A executes the processing program 100 to function as an acquisition unit 200, a determination unit 210, a diagnosis unit 220, a calculation unit 230, and a notification unit 240, in the center server 30 of the present embodiment.

The acquisition unit 200 has a function of acquiring the vehicle information related to the state and control of the vehicle 12 and location information of the vehicle 12 from the on-board unit 20 of the vehicle 12. The acquisition unit 200 acquires the vehicle information and the location information from the on-board unit 20 at regular intervals or optional timings.

The determination unit 210 has a function of determining whether or not the accident or failure has occurred based on the vehicle information acquired by the acquisition unit 200. For example, in a case where an acceleration exceeding a predetermined threshold is detected, the determination unit 210 determines that an accident including a collision has occurred. For example, in a case where a diagnostic trouble code (DTC) indicating the failure of the ECU 22 or the in-vehicle device 24 is acquired from the vehicle information, the determination unit 210 determines that a failure has occurred in the ECU 22 or the in-vehicle device 24 corresponding to the DTC. For example, in a case where a minor collision between the body and another vehicle, or a dent on a body panel is detected from an image captured by an outside camera (not shown), the determination unit 210 determines that an accident including body deformation of the vehicle 12 has occurred. Accidents and failures herein are examples of the event described in the present disclosure.

The diagnosis unit 220 has a function of diagnosing driving behaviors of the driver who drives the vehicle 12 based on the vehicle information. For example, sudden braking or sudden steering is diagnosed based on the acceleration included in the vehicle information and the steering angle of the steering wheel. For example, eco-friendly driving is diagnosed based on fuel consumption information included in the vehicle information. The diagnosis outcomes made by the diagnosis unit 220 may be transmitted to the terminal 40 owned by the administrator of the vehicle 12 to be provided to the administrator, or transmitted to the on-hoard unit 20 to be provided to the driver who drives the vehicle 12.

The calculation unit 230 has a function of calculating the cost in a case where the accident or failure has occurred in the vehicle 12. Calculated costs include vehicle repair costs, occupant treatment costs, insurance costs, leave compensation, and paperwork costs for dealing with accidents and failures, as stated above. The calculation unit 230 calculates the total cost, which is the sum of the costs calculated for the predetermined period. The predetermined period may be a fixed number of years or months, or may be a contract period of the driving diagnosis service. The calculation unit 230 also has a function of calculating the usage amount of the driving diagnosis service.

The notification unit 240 has a function of transmitting, tier example, the cost of the accident or failure calculated by the calculation unit 230, the total cost for the predetermined period, and the usage amount to the terminal 40 owned by the administrator of the vehicle 12 to notify the administrator.

Flow of Control

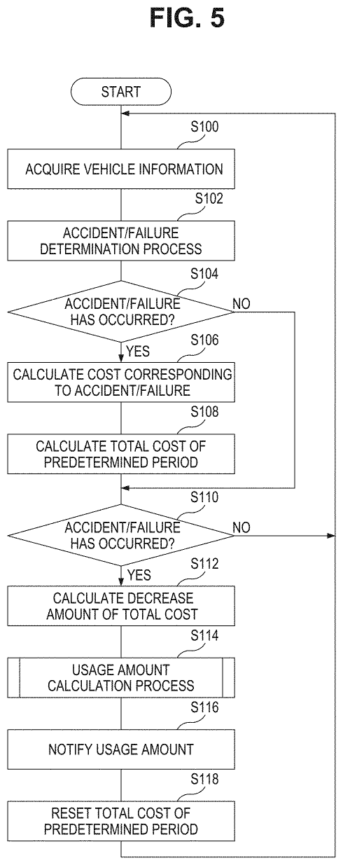

In the present embodiment, a flow of the calculation notification process executed by the center server 30 when determining the usage amount of the driving diagnosis service will be described with reference to the flowchart of FIG. 5. The process is executed by the CPU 30A of the center server 30 functioning as the acquisition unit 200, the determination unit 210, the diagnosis unit 220, the calculation unit 230, and the notification unit 240.

In step S100 of FIG. 5, the CPU 30A acquires the vehicle information. In particular, the CPU 30A acquires the vehicle information from the on-board unit 20 of the vehicle 12 that is a target of the driving diagnosis service.

In step S102, the CPU 30A executes an accident/failure determination process. In particular, the process of the determination unit 210 described above is executed.

In step S104, the CPU 30A determines whether or not at least one of the accident and the failure has occurred. If the CPU 30A determines that at least one of the accident and the failure has occurred (YES in step S104), the process proceeds to step S106. On the other hand, if the CPU 30A determines that at least one of the accident and the failure has not occurred, (NO in step S104), the process proceeds to step S110.

In step S106, the CPU 30A calculates the cost corresponding to the accident and/or the failure.

In step S108, the CPU 30A calculates the total cost of the predetermined period. In other words, the CPU 30A integrates the costs calculated in step S106.

In step S110, the CPU 30A determines whether the predetermined period has elapsed. In a case where it is determined that the predetermined period has elapsed (YES in step S110), the CPU 30A proceeds to step S112. Meanwhile, in a case where it is determined that the predetermined period has not elapsed (NO in step S110), the CPU 30A returns to step S100.

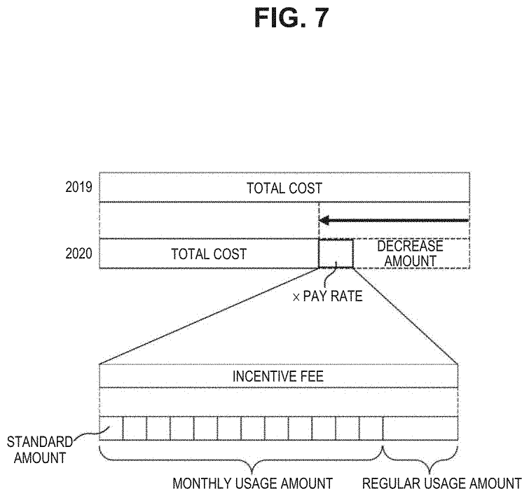

In step S112, the CPU 30A calculates a decrease amount of the total cost. In particular, the CPU 30A calculates the decrease amount by subtracting the total cost calculated in step S108 from the total cost of the past predetermined period. For example, assuming that the predetermined period is one year, the decrease amount is calculated by subtracting the total cost of 2020 from the total cost of 2019, as shown in FIG. 7. The total cost of the past predetermined period may be the total cost calculated in the past and stored in the total cost database 110, or may be monetary data previously input to the center server 30.

In step S114, the CPU 30A executes a usage amount calculation process. The details of the usage amount calculation process will be described later.

In step S116, the CPU 30A notifies the administrator of the vehicle 12 of the calculated usage amount. That is, the usage amount is transmitted to the terminal 40 owned by the administrator of the vehicle 12 using the driving diagnosis service.

In step S118, the CPU 30A resets the total cost of the predetermined period. The process returns to step S100.

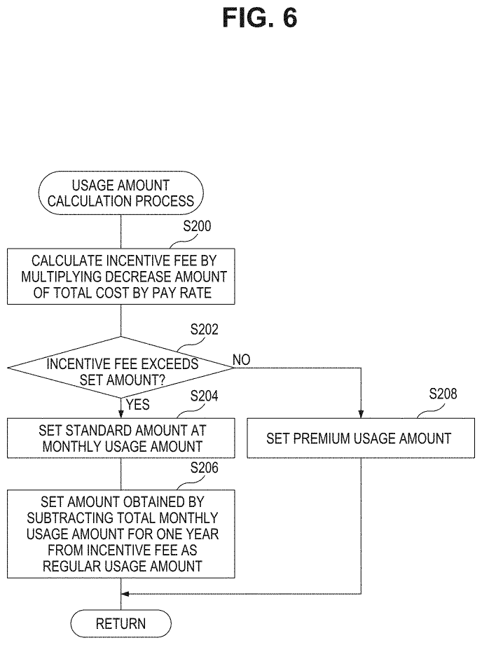

A flow of the usage amount calculation process in step S114 will be described with reference to the flowchart of FIG. 6.

In step S200 as shown in FIG. 6, the CPU 30A calculates the incentive fee by multiplying the decrease amount of the total cost by the pay rate (see FIG. 7).

In step S202 the CPU 30A determines whether the incentive fee exceeds a set amount. In a case where it is determined that the incentive fee exceeds the set amount (YES in step S202), the CPU 30A proceeds to step S204. Meanwhile, in a case where it is determined that the incentive fee fails to exceed the set amount (NO in step S202), the CPU 30A proceeds to step S208.

In step S204, the CPU 30A sets a predetermined standard amount as a monthly usage amount (see FIG. 7). One month is an example of a first period, and the monthly usage amount is an example of a first usage amount.

In step S206, the CPU 30A sets an amount obtained by subtracting the total monthly usage amount for one year from the incentive fee as a regular usage amount (see FIG. 7). One year is an example of a second period. The regular usage amount is an example of a second usage amount. Then, the usage amount calculation process is terminated.

In step S208, the CPU 30A sets a premium usage amount higher than the standard amount as the monthly usage amount. The premium usage amount is an example of a third usage amount. Then, the usage amount calculation process is terminated.

Summary

The center server 30 of the present embodiment calculates the usage amount of the driving diagnosis service for the vehicle 12. The center server 30 calculates the cost for every detected event, including at least one of the accident and the failure, based on the vehicle information of the vehicle 12, and calculates the total cost by accumulating all individually calculated costs. The center server 30 calculates the decrease amount from the total cost in the past, and multiplies the decrease amount by the pay rate to calculate the usage amount.

With the present embodiment, it is possible to promote the introduction of the driving diagnosis service in which the usage amount of the driving diagnosis service reflects the cost reduction corresponding to the specific event, such as an accident. In particular, with the present embodiment, the usage amount of the driving diagnosis service is paid from the cost reduction, thus the user can easily introduce and enjoy the benefits of the service.

The center server 30 of the present embodiment calculates the usage amount every predetermined period. In other words, according to the present embodiment, the usage amount can be calculated again every certain period and every contract term.

In the center server 30 of the present embodiment, the usage amount is calculated separately as both a short-term monthly usage amount and a long-term regular usage amount. For example, it is possible to set the monthly usage amount as a usage amount that is sufficient in terms of maintaining infrastructure, and the regular usage amount as an incentive fee. Therefore, with the present embodiment, it is possible for the administrator of the vehicle 12 to easily introduce the driving diagnosis service and keep offering the driving diagnosis service.

If the driving diagnosis service has been introduced but not used to a certain. extent and thus the incentive fee has not reached the set amount, the center server 30 of the present embodiment calculates the premium usage amount that is higher than the monthly usage amount. In such a case, the set amount. may be set to, for example, the cost required for maintaining the infrastructure. With the present embodiment, it is possible to promote the service by increasing the usage amount when the user does not use the driving diagnosis service to a certain extent.

### Second Embodiment

In the first embodiment, the usage amount is calculated in response to the trigger which is a case where the predetermined period has elapsed in the calculation notification process. However, the calculation trigger in a second embodiment is different from that in the first embodiment. Hereinafter, the description will be made focusing on the differences from the first embodiment. Since the configuration is the same as that of the first embodiment, the descriptions thereof will be omitted.

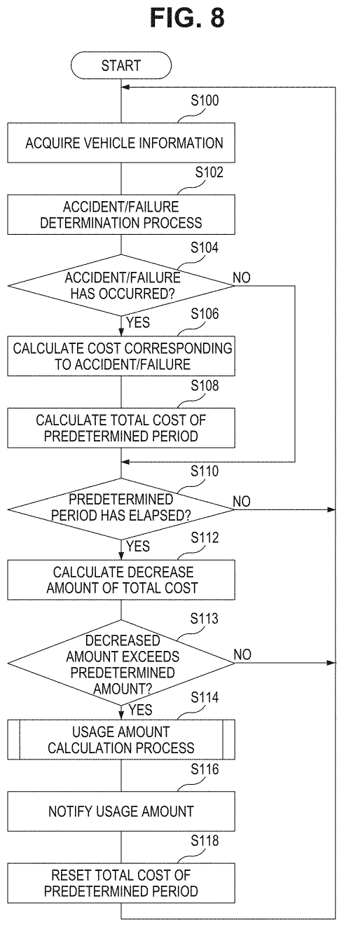

A flow of the calculation notification process of the present embodiment will be described referring to the flowchart of FIG. 8. The calculation notification process of the present embodiment includes the same steps as those in the first embodiment, except that step S113 is added.

In step S112 as shown in FIG. 8, the CPU 30A calculates the decrease amount of the total cost, and then proceeds to step S113.

In step S113, the CPU 30A determines whether the decrease amount of the total cost exceeds a predetermined amount. In a case where it is determined that the decrease amount of the total cost exceeds the predetermined amount (YES in step S113), the CPU 30A proceeds to step S114. Meanwhile, in a case where it is determined that the decrease amount of the total cost fails to exceed the predetermined amount (NO in step S113), the CPU 30A returns to step S100.

As described above, in the calculation notification process of the present embodiment, the usage amount of the driving diagnosis service is calculated when the decrease amount of the total cost exceeds the predetermined amount. Therefore, with the present embodiment, the usage amount can be calculated when the user can get meaningful outcomes from the driving diagnosis service, in addition to the advantageous effects obtained from the first embodiment.

Remarks

In the usage amount calculation process of the embodiment stated above, the incentive fee is calculated by multiplying the decrease amount of the total cost by the preset pay rate. However, the present disclosure is not limited thereto. The incentive fee may be an amount obtained by multiplying the decrease amount of the total cost by a variable ratio. The variable ratio can be set according to various factors of the service, for example, target audience or frequency of use. As one example, if the variable ratio is set to be lower at the initial stage where the driving diagnosis service is released, the introduction of the service can be promoted. With the present embodiment, the introduction of the driving diagnosis service can be further promoted by calculating the usage amount according to various factors of the service, for example, target audience or frequency of use.

In the driving diagnosis service in the above embodiment, the administrator and the driver of the vehicle 12 who are users of the service can access the diagnosis results and raise the awareness of safety, thereby accidents and failures can be suppressed. It is also thus expected that the operating cost of the vehicle 12 will be reduced. Therefore, the number of times the diagnosis results are accessed may be set to be reflected in the usage amount in each embodiment. For example, the variable ratio stated above may be set according to the number of times the diagnosis results are accessed.

Various processes, executed by the CPUs 20A and 30A reading the software (program) in each of the embodiments, may be executed by processors other than the CPU. Examples of the processor include a programmable logic device (PLD), such as a field programmable gate array (FPGA) capable of changing a circuit configuration after manufacturing, and a dedicated electrical circuit that is a processor having a circuit configuration specifically designed to execute a specific process, such as an application specific integrated circuit (ASIC). Further, each process stated above may be executed by one of these processors, or a combination of at least two processors which are the same or different (for example, a plurality of FPGAs, or a combination of CPU and FPGA). The hardware structure of these processors is, more specifically, an electric circuit in which circuit elements such as semiconductor elements are combined.

In the embodiments stated above, each program is stored (installed) in a non-transitory recording medium readable by a computer in advance. For example, the control program 50 for the on-board unit 20 is stored in advance in the ROM 20B, and the processing program 100 for the center server 30 is stored in advance in the storage 30D. However, the present disclosure is not limited thereto. The programs may be provided in a non-transitory recording medium such as a compact disk read only memory (CD-ROM), a digital versatile disk read only memory (DVD-ROM), or a universal serial bus (USB) memory. Further, the programs may be downloaded from an external device via a network.

The process flows described in the embodiments stated above are mere examples, and unnecessary steps may be omitted, new steps may be added, or the process order may be changed without departing from the scope of the present disclosure.

What is claimed is:

1. An information processing device comprising:
a processor configured to:
detect a predetermined event based on vehicle information on a vehicle;
calculate a cost for each detected event;
calculate a decrease amount obtained by subtracting a total cost, which is a sum of costs for a predetermined period, from a total cost for a past predetermined period; and
calculate a usage amount of a service that provides information on driving behaviors of a driver who drives the vehicle based on the calculated decrease amount.

2. The information processing device according to claim 1, wherein the processor is configured to calculate the usage amount in response to a predetermined trigger.

3. The information processing device according to claim 2, wherein the predetermined trigger is a case where the decrease amount is a predetermined amount.

4. The information processing device according to claim 1, wherein the processor is configured to calculate, as the usage amount, an amount obtained by multiplying the decrease amount by a variable ratio.

5. The information processing device according to claim wherein the processor is configured to calculate, as the usage amount, a first usage amount collected every first period, and a second usage amount which is collected every second period and is obtained by subtracting a total sum of the first usage amount from the usage amount, the second period being longer than the first period.

6. The information processing device according to claim 5, wherein the processor is configured to, in a case where the service has been introduced but not used to certain extent calculate a third usage amount which is higher than the first usage amount and is collected every first period instead of the first usage amount.

7. A calculation method executed by a computer, the calculation method comprising:
detecting a predetermined event based on vehicle information on a vehicle;
calculating a cost for each detected event;
calculating a decrease amount obtained by subtracting a total cost, which is a sum of costs for a predetermined period, from a total cost for a past predetermined period; and
calculating a usage amount of a service that provides information on driving behaviors of a driver who drives the vehicle based on the calculated decrease amount.

8. A calculation program causing a computer to execute:
detecting a predetermined event based on vehicle information on a vehicle;
calculating a cost for each detected event;
calculating a decrease amount obtained by subtracting a total cost, which is a sum of costs for a predetermined period, from a total cost for a past predetermined period; and
calculating a usage amount of a service that provides information on driving behaviors of a driver who drives the vehicle based on the calculated decrease amount.
